(19) United States
(12) Patent Application Publication
(10) Pub. No.: US 2015/0185651 A1
(43) Pub. Date: Jul. 2, 2015

(54) TONER USED FOR FORMING IMAGE

(71) Applicants: Toshiba Tec Kabushiki Kaisha, Tokyo (JP); Kabushiki Kaisha Toshiba, Tokyo (JP)

(72) Inventor: KOICHI KUROYAMA, Kanagawa-ken (JP)

(73) Assignees: Toshiba Tec Kabushiki Kaisha, Tokyo (JP); Kabushiki Kaisha Toshiba, Tokyo (JP)

(21) Appl. No.: 14/145,510

(22) Filed: Dec. 31, 2013

(51) Int. Cl. G03G 9/00

(52) U.S. Cl. CPC G03G 9/08782; G03G 9/08755

(57) ABSTRACT

A toner includes a binder resin, a colorant, a wax including 40 to 80 weight percent of an ester wax having an endothermic peak temperature of 65 to 75° C. in a differential scanning calorimetry curve and 60 to 20 weight percent of a carnauba wax having an endothermic peak temperature of 80 to 90° C. in the differential scanning calorimetry curve, and a crystalline polyester material. With respect to the total weight of the binder resin, the wax, and the crystalline polyester material, the wax comprises 4 to 10 weight percent and the crystalline polyester material comprises 3 to 20 weight percent.

### FIELD

Exemplary embodiments described herein relate to toner used by an image forming apparatus.

### BACKGROUND

One type of an image forming apparatus employs a technology to save toner used for forming an image. For example, such an image forming apparatus includes a waste toner recycling system, with which residual toner remaining on a photoreceptor is supplied from a cleaning unit to a developing unit. In addition, another type of an image forming apparatus employs a technology to conserve energy that is consumed. For example, such an image forming apparatus forms a toner image with a unique toner that is fixable at a lower temperature. Examples a toner material are ester wax and crystalline polyester resin. These materials have superior fixability compared to toner containing carnauba wax.

However, toner containing the ester wax or the crystalline polyester resin has a lower wax dispersion characteristic compared to toner containing the carnauba wax. Because of this characteristic, the amount of a wax in the waste toner is greater. If such toner is used in the image forming apparatus having the recycling system, quality of the toner image will be deteriorated.

### DESCRIPTION OF THE DRAWING

FIG. 1 is a cross-sectional view of an image forming apparatus that forms an image with toner according to one exemplary embodiment.

### DETAILED DESCRIPTION

In general, according to one embodiment, toner includes two types of wax having different endothermic peaks and crystalline polyester. With these components, was dispersion is improved. Thus, even with an image forming apparatus having a recycling system, a quality of the toner image is maintained while the toner image can be fixed at a lower temperature.

One type of wax used is an ester wax and has an endothermic peak at 65° C. to 75° C., in a differential scanning calorimetry (DSC) curve measured by differential scanning calorimetry. In addition, another type of was used is a carnauba wax and has an endothermic peak at 80° C. to 90° C. For securing a non-offset region, a difference in the endothermic peak temperatures is 5° C. to 25° C., and a ratio of wax additive amounts is between 40:60 and 80:20 (ester wax:carnauba wax). Further, for preventing degradation of low temperature fixability due to the use of the carnauba wax, a small amount of crystalline polyester is used in combination.

According to a detailed exemplary embodiment, a toner includes a binder resin, a colorant, a wax including 40 to 80 weight percent of an ester wax having an endothermic peak temperature of 65 to 75° C. in a differential scanning calorimetry curve and 60 to 20 weight percent of a carnauba wax having an endothermic peak temperature of 80 to 90° C. in the differential scanning calorimetry curve, and a crystalline polyester material. With respect to the total weight of the binder resin, the wax, and the crystalline polyester material, the wax comprises 4 to 10 weight percent and the crystalline polyester material comprises 3 to 20 weight percent.

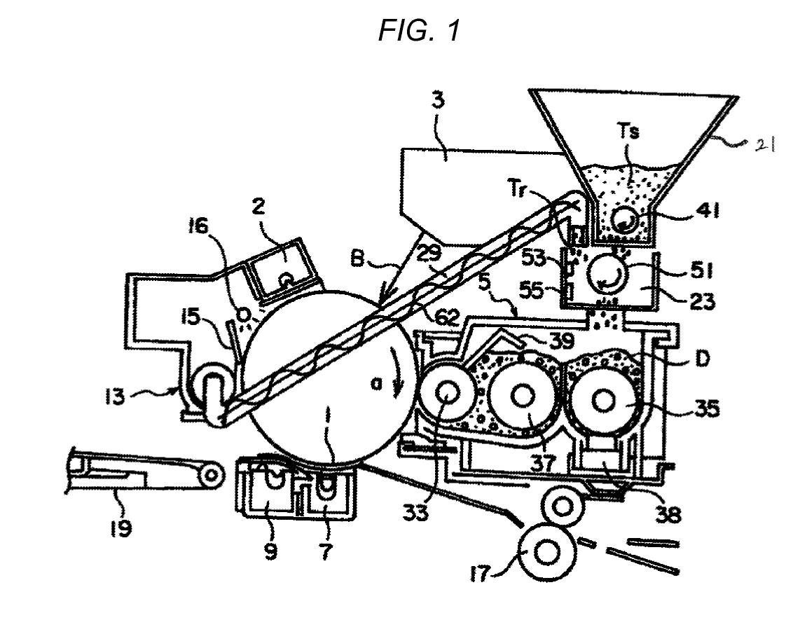

Hereinafter, an image forming apparatus used for an image forming with toner according to one exemplary embodiment will be described with reference to the drawing. A copying machine will be described as an example of such an image forming apparatus. FIG. 1 is a cross-sectional view of a main part of the copying machine as an example.

The main part of the copying machine shown in FIG. 1 includes a photoreceptor 1 as an image holding member. The photoreceptor 1 rotates in a direction of an arrow a shown in FIG. 1.

An electrification charger 2, an exposure device 3 which irradiates the charged photoreceptor 1 with a laser beam B to form an electrostatic latent image, a developing device 5 which develops the electrostatic latent image with toner, a transfer device 7 which transfers a developed toner image onto paper, a separating device 9 which separates the paper from the photoreceptor 1, a cleaning device 13 which removes the toner remaining on the photoreceptor 1, and the like are provided around the photoreceptor 1. The cleaning device 13 includes a cleaning blade 15 which contacts the photoreceptor and removes the toner on the photoreceptor, and a discharging lamp 16 for discharging the photoreceptor 1 from which the toner is removed.

The paper is discharged from a paper feeding cassette (not shown) and is transported towards the photoreceptor 1 by a transportation roller 17 or the like. Paper to which the toner image on the photoreceptor is transferred by the transfer device 7 is transported towards a fixing device (not shown) by a transportation belt 19.

The developing device 5 accommodates a developer D as an initial developer. The developer D is a two-component developer configured of toner and carrier. The developer D will be specifically described below.

A toner supply unit 21 which accommodates toner for supply is provided above the developing device 5, to refill the developing device 5 in accordance with consumption of the initial developer in the developing device. A toner mixing unit 23 is provided between the toner supply unit 21 and the developing device 5. A recycling device 29, which supplies the used toner collected by the cleaning device 13 to the toner mixing unit 23 to reuse the toner, is provided between the toner mixing unit 23 and the cleaning device 13.

The developing device 5 accommodates the developer D including the toner and the carrier as the initial developer, and also includes a developing roller 33 which opposes the photoreceptor 1. A stirring roller 35, which stirs the developer D in the developing device 5, and a supply roller 37, which supplies the developer stirred by the stirring roller 35 to the developing roller 33, are provided in the developing device 5. In addition, a sensor 38 used to determine a mixing ratio of the toner to the carrier in the developing device 5 based on magnetic permeability, is disposed below the stirring roller 35. Further, a doctor blade 39 which forms a thin layer of the developer D supplied from the supply roller 37 on the developing roller is disposed to oppose the developing roller 33.

The toner supply unit 21 internally accommodates toner TS for supply. In addition, the toner supply unit 21 includes a toner supply roller 41 which supplies the toner to the toner mixing unit 23. A suitable amount of the toner TS which is accommodated in the toner supply unit 21 is dropped into the toner mixing unit 23 in accordance with the rotation of the toner supply roller 41.

The toner TS and recycled toner Tr which is transported by the recycling device 29 are supplied to the toner mixing unit 23. The toner mixing unit 23 includes a mixing roller 51 which stirs and mixes the toner TS and the recycled toner Tr. A sensor 53 which detects an amount of toner in the toner mixing unit 23 is provided in the toner mixing unit 23. The toner supply roller 41 is driven and rotated based on an amount of the toner detected by the sensor 53. In addition, the mixing roller 51 rotates based on the amount of the toner detected by the sensor 38, and the toner in the mixing unit 23 is supplied into the developing device 5.

The recycling device 29 includes a transportation auger 62, and transports the toner removed by the cleaning blade 15 to the toner mixing unit 23 by the rotation of the transportation auger 62.

Hereinafter, the toner according to the exemplary embodiment will be described.

A binder resin (here, corresponding to a main component of the toner except a wax and a crystalline polyester) is not particularly limited. However, a polyester resin is desirable from a viewpoint of compatibility with the crystalline polyester. The binder resin can be prepared using compounds exemplified in JP-A-7-175260 and with reference to a method described therein, for example.

As a raw material monomer of polyester, divalent or higher alcohol components and carboxylic acid components such as divalent or higher carboxylic acid, carboxylic anhydride, and carboxylic ester are used.

Examples of the divalent alcohol components include bisphenol A alkylene oxide adducts such as polyoxypropylene (2.2)-2,2-bis(4-hydroxyphenyl) propane, polyoxypropylene (3.3)-2,2-bis(4-hydroxyphenyl) propane, polyoxyethylene (2.0)-2,2-bis(4-hydroxyphenyl) propane, polyoxypropylene (2.0)-polyoxyethylene (2.0)-2,2-bis(4-hydroxyphenyl) propane, or polyoxypropylene (6)-2,2-bis(4-hydroxyphenyl) propane, ethylene glycol, diethylene glycol, triethylene glycol, 1,2-propylene glycol, 1,3-propylene glycol, 1,4-butanediol, neopentyl glycol, 1,4-butenediol, 1,5-pentanediol, 1,6-hexanediol, 1,4-cyclohexanedimethanol, dipropylene glycol, polyethylene glycol, polypropylene glycol, polytetramethylene glycol, bisphenol A, hydrogenated bisphenol A, and the like.

Preferred divalent alcohol components are bisphenol A alkylene (2 or 3 carbon atoms) oxide adducts (average addition mole number of 1 to 10), ethylene glycol, propylene glycol, 1,6-hexandiol, bisphenol A, hydrogenated bisphenol A, and the like.

Examples of trivalent or higher alcohol components include sorbitol, 1,2,3,6-hexanetetrol, 1,4-sorbitan, pentaerythritol, dipentaerythritol, tripentaerythritol, 1,2,4-butanetriol, 1,2,5-pentanetriol, glycerol, 2-methylpropanetriol, 2-methyl-1,2,4-butanetriol, trimethylolethane, trimethylolpropane, 1,3,5-trihydroxymethylbenzene, and the like. Preferable trivalent or higher alcohol components are sorbitol, 1,4-sorbitan, pentaerythritol, glycerol, trimethylolpropane, and the like. In the exemplary embodiment, the divalent alcohol and trivalent or higher alcohol can be used alone or with a plurality of components in combination.

Examples of divalent carboxylic acid components include maleic acid, fumaric acid, citraconic acid, itaconic acid, glutaconic acid, phthalic acid, isophthalic acid, terephthalic acid, cyclohexane dicarboxylic acid, succinic acid, adipic acid, sebacic acid, azelaic acid, malonic acid, alkenyl succinic acid such as n-dodecenyl succinic acid, alkyl succinic acid such as n-dodecyl succinic acid, anhydrides or lower alkyl esters of these acids, and the like. Preferable divalent carboxylic acid components are maleic acid, fumaric acid, terephthalic acid, and succinic acid substituted by an alkenyl group having 2 to 20 carbon atoms.

Examples of trivalent or higher carboxylic acid components include 1,2,4-benzene tricarboxylic acid, 2,5,7-naphthalene tricarboxylic acid, 1,2,4-naphthalene tricarboxylic acid, 1,2,4-butanetricarboxylic acid, 1,2,5-hexane tricarboxylic acid, 1,3-dicarboxyl-2-methyl-2-methylene carboxy propane, 1,2,4-cyclohexane tricarboxylic acid, tetra(methylene carboxyl) methane, 1,2,7,8-octane tetracarboxylic acid, pyromellitic acid, Empol trimer acid, anhydrides or lower alkyl esters thereof, and the like.

Preferable trivalent or higher carboxylic acid components are 1,2,4-benzene tricarboxylic acid (trimellitic acid), anhydrides or alkyl (1 to 12 carbon atoms) esters thereof, and the like. In the exemplary embodiment, the divalent carboxylic acid, and the trivalent or higher carboxylic acid can be used alone or with a plurality of components in combination.

When polymerizing the raw material monomers of the polyester, a generally-used esterification catalyst such as dibutyl tin oxide may be appropriately used for promoting the reaction.

As the polyester resin used as the main component of the binder resin in the exemplary embodiment, an amorphous polyester resin in which a softening point is 100° C. to 115° C., a ratio of the softening point and a maximum endothermic peak temperature (softening point/peak temperature) is greater than 1.3, particularly 1.5 to 5.0, a glass transition temperature is 55° C. to 65° C., particularly 58° C. to 62° C., and an acid value is 5 mg-KOH/g to 20 mg-KOH/g, particularly 8 mg-KOH/g to 15 mg-KOH/g obtained by appropriate combination of the alcohol and the carboxylic acid, is preferably used.

In the exemplary embodiment, in the combination with the binder resin, combination of wax components formed of 40% by weight to 80% by weight of ester wax having an endothermic peak in a range of 65° C. to 75° C. in a DSC curve and 60% by weight to 20% by weight of carnauba wax having an endothermic peak in a range of 80° C. to 90° C. in a DSC curve, is used.

As the ester wax, ester wax which is obtained by an esterification reaction with at least one of long-chain alkyl carboxylic acid components such as palmitic acid (C16H32O2), stearic acid (C18H36O2), arachidonic acid (C20H40O2), behenic acid (C22H44O2), and lignoceric acid (C24H48O2), and one or more kinds of long-chain alkyl alcohol components such as palmityl alcohol (C16H34O), stearyl alcohol (C18H38O), arachidyl alcohol (C20H42O), behenyl alcohol (C22H46O), and lignoceryl alcohol (C24H48O), and which has an endothermic peak in a range of 65° C. to 75° C. in a DSC curve, is used. If the endothermic peak temperature thereof is lower than 65° C., even with the combination with predetermined carnauba wax, it is difficult to avoid filming on the photoreceptor due to scattering of the toner, when the ester wax is used in the image forming apparatus including a waste toner recycling mechanism and a continuous operation of a plurality of sheets is performed. If the DSC peak temperature thereof exceeds 75° C., it is difficult to obtain an improvement effect of the low temperature fixability due to combination with the ester wax.

Meanwhile, as the carnauba wax, carnauba wax in which the DSC peak temperature is adjusted to a range of 80° C. to 90° C., by adjusting a purification degree of the resin acquired from a carnauba palm tree, is used. If the DSC peak temperature thereof is lower than 80° C., dispersion of the carnauba wax is degraded, a high temperature offset is narrowed, and the offset region is degraded. If the DSC peak temperature thereof exceeds 90° C., it is difficult to avoid degradation of the low temperature fixability, even with the combination with the crystalline polyester which will be described later.

Content of the ester wax in the wax component is set to 40% by weight to 80% by weight, and content of the carnauba wax is set to 60% by weight to 20% by weight. If the content of the ester wax is excessive, it is difficult to solve malfunction when performing waste toner recycling, and if the carnauba wax is excessive, the degradation of the low temperature fixability becomes considerable.

The ester wax and the carnauba wax, in total, is used with respect to 100 pbw of the binder resin (including wax and crystalline polyester) of the toner of the exemplary embodiment at a ratio of 4 pbw to 10 pbw. If the added amount thereof is less than 4 pbw, the low temperature fixability is degraded. If the added amount thereof exceeds 10 pbw, the toner filming on the photoreceptor is degraded.

By further adding the crystalline polyester in the toner of the exemplary embodiment, the degradation of the low temperature fixability due to the use of the carnauba wax is prevented. The crystalline polyester is not particularly limited, and, for example, can be obtained by polycondensation of diol and dicarboxylic acid. Examples of diol include ethylene glycol, 1,3-propanediol, 1,4-butanediol, 1,5-pentanediol, 1,6-hexanediol, 1,7-heptanediol, 1,8-octanediol, 1,9-nonanediol, 1,10-decanediol, 1,11-undecanediol, 1,12-dodecanediol, 1,13-tridecanediol, 1,14-tetradecanediol, 1,18-octadecanediol, 1,20-eicosanediol, and the like. Examples of dicarboxylic acid include terephthalic acid, isophthalic acid, orthophthalic acid, t-butyl isophthalic acid, 2,6-naphthalene dicarboxylic acid, 4,4′-biphenyl dicarboxylic acid, fumaric acid, adipic acid, sebacic acid, 1,10-decane dicarboxylic acid, 1,12-dodecane dicarboxylic acid, and the like. Among them, a carboxylic acid component containing 60 mol % or more of aliphatic dicarboxylic acids having 2 to 8 carbon atoms, particularly fumaric acid, is preferably used.

As the crystalline polyester, crystalline polyester in which a softening point is 95° C. to 110° C., a ratio of the softening point and a maximum endothermic peak temperature (softening point/peak temperature) is 0.6 to 1.3, preferably 0.8 to 1.1, and an acid value is 5 mg-KOH/g to 15 mg-KOH/g, particularly, 8 mg-KOH/g to 12 mg-KOH/g obtained by appropriate combination of the diol and the dicarboxylic acid, is preferably used.

Japanese Patent No. 3693327 (description thereof is included in the present specification as a reference) can be referred to for even more specific description of the crystalline polyester and the amorphous polyester resin, and the preparing method thereof used in the exemplary embodiment.

The crystalline polyester is used with respect to 100 pbw of the binder resin (including wax and crystalline polyester) of the toner of the exemplary embodiment at a ratio of 3 pbw to 20 pbw, preferably 3 pbw to 18 pbw. If the content thereof is less than 3 pbw, the low temperature fixability is degraded. If the content thereof exceeds 20 pbw, a storage property at high temperature is degraded and fixation of the toner tends to occur.

As the colorant used in the exemplary embodiment, carbon black or an organic or inorganic pigment or dye is used. The colorant is not particularly limited. However, examples of the carbon black include acetylene black, furnace black, thermal black, channel black, ketjen black, and the like. Examples of the pigment or dye include Fast Yellow G, Benzidine Yellow, India Fast Orange, Irgazin red, naphthol azo, Carmine FB, permanent Bordeaux FRR, Pigment Orange R, Lithol Red 2G, Lake Red C, rhodamine FB, rhodamine B lake, phthalocyanine blue, Pigment Blue, Brilliant Green B, phthalocyanine green, quinacridone, and the like. Examples of desirable yellow pigments include C.I. Pigment Yellow 1, 2, 3, 4, 5, 6, 7, 10, 11, 12, 13, 14, 15, 16, 17, 23, 65, 73, 74, 81, 83, 93, 95, 97, 98, 109, 117, 120, 137, 138, 139, 147, 151, 154, 167, 173, 180, 181, 183, 185, C.I. Vat Yellow 1, 3, 20, and the like. These components can be used alone or as a mixture. Examples of desirable magenta pigments include C.I. Pigment Red 1, 2, 3, 4, 5, 6, 7, 8, 9, 10, 11, 12, 13, 14, 15, 16, 17, 18, 19, 21, 22, 23, 30, 31, 32, 37, 38, 39, 40, 41, 48, 49, 50, 51, 52, 53, 54, 55, 57, 58, 60, 63, 64, 68, 81, 83, 87, 88, 89, 90, 112, 114, 122, 123, 146, 150, 163, 184, 185, 202, 206, 207, 209, 238, C.I. Pigment Violet 19, C.I. Vat Red 1, 2, 10, 13, 15, 23, 29, 35, and the like. These components can be used alone or as a mixture. Examples of desirable cyan pigments include C.I. Pigment Blue 2, 3, 15, 16, 17, C.I. Vat Blue 6, C.I. Acid Blue 45, and the like. These components can be used alone or as a mixture.

In the exemplary embodiment, a charge control agent for controlling frictional charge amounts may be combined. As such a charge control agent, a metal-containing azo compound is used, and a complex or a complex salt of iron, cobalt, or chromium as a metal element, or a mixture thereof is desirable. In addition, a metal-containing salicylic acid derivative compound may also be used, and a complex or a complex salt of zirconium, zinc, chromium, and boron as a metal element, or a mixture thereof is desirable.

In the exemplary embodiment, a method of preparing the toner may be a grinding method or a chemical method, and it is not particularly limited. However, in a case of a chemical method, a method capable of using the polyester resin is desirable, and a method disclosed in JP-A-2007-323071 is more desirable since an organic solvent is not used.

In the exemplary embodiment, 0.01% by weight to 10% by weight of inorganic fine particles may be additionally combined with respect to the toner particles, for adjusting fluidity or a charging property of the toner particles. As such inorganic fine particles, it is possible to use silica, titania, alumina, strontium titanate, tin oxide, and the like alone or as a mixture with two or more kinds. It is preferable to use inorganic fine particles which are subjected to surface treatment by a hydrophobizing agent, from a viewpoint of improvement of environmental stability. In addition, other than such inorganic fine particles, resin fine particles having a size of 1 μm or less may be added for improving a cleaning property.

Examples of a mixer for the inorganic fine particles or the like include Henschel mixer (manufactured by Mitsui Mining Co., Ltd.), Super mixer (manufactured by KAWATA MFG Co., Ltd.), RIBOCONE (manufactured by OKAWARA MFG. CO., LTD.), Nauta mixer (manufactured by Hosokawa Micron Group), Turbulizer (manufactured by Hosokawa Micron Group), Cyclomix (manufactured by Hosokawa Micron Group), Spiral Pin Mixer (manufactured by Pacific Machinery & Engineering Co., Ltd.), and Loedige Mixer (manufactured by MATSUBO Corporation).

In the exemplary embodiment, coarse particles may be further sieved. Examples of a sieving device used for a sieve include Ultra Sonic (manufactured by Koei Sangyo Co., Ltd.), Gyro-Shifter (manufactured by TOKUJU Co., Ltd.), Vibrasonic System (manufactured by DALTON CO., LTD.), SONICLEAN (manufactured by SINTOKOGIO, LTD.), Turbo Screener (manufactured by FREUND TURBO), Micro Shifter (manufactured by Makino Mfg. Co. Ltd.), a circular vibrating screen, and the like.

As described above, a volume average particle size (measured value obtained by an aperture-attached Coulter counter having a diameter of 100 μm) of the toner of the exemplary embodiment is generally set to 6 μm to 8 μm.

The toner can be used as a one-component developer as it is, and also can be used as a two-component developer containing the toner, for example, at a ratio of 5% by weight to 10% by weight by mixing with a ferrite carrier surface-coated with a silicone resin, for example.

### EXAMPLES

Hereinafter, exemplary embodiments will be further specifically described with reference to Examples and Comparative Examples. With the following description, measurement of a physical property value and evaluation of the obtained toner disclosed in the present specification are performed with the following methods.

### (1) Softening Point

Using a Koka type flow tester (CFT-500D manufactured by Shimadzu Corporation), while heating 1 g of a sample at a temperature rising rate of 6° C./min, a load of 1.96 MPa was applied thereto by a plunger. The resultant material was extruded from a nozzle having a diameter of 1 mm and a length of 1 mm, and accordingly a plunger drop amount (flow value) by the flow tester-temperature curve was drawn. When a height of an S-curve thereof was set to h, a temperature corresponding to h/2 (temperature at which a half of the resin flows out) was set to a softening point.

### (2) DSC Peak Temperature

A DSC (differential scanning calorimeter) “DSC Q2000 (manufactured by TA Instruments. Japan)” was used for measurement of DSC peak temperatures of the ester wax, the carnauba wax, the crystalline and amorphous polyesters, and the toner. The measurement thereof was performed in conditions of a sample amount of 5 mg, a cover and pan made of aluminum, a temperature rising rate of 10° C./min, and a measurement temperature of 20° C. to 200° C. The sample which was heated to 200° C. was cooled to 20° C. or lower at a temperature dropping rate of 10° C./min, and was heated again. The measured result was converted into data, and a maximum endothermic peak of a next heating process was measured.

In the DSC peak measurement of the toner sample, a maximum endothermic peak which was generated from a vicinity of 60° C. to a vicinity of 80° C. was set to a melting point of the ester wax, and a maximum endothermic peak which was generated from a vicinity of 80° C. to a vicinity of 95° C. was set to a melting point of the carnauba wax. In addition, a maximum endothermic peak which was generated from a vicinity of 95° C. to a vicinity of 120° C. was set to a melting point of the crystalline polyester resin.

### (3) Mass Spectrometry of Ester Wax

Mass spectrometry of the ester wax which was obtained by a preparation example of the wax which will be described later, was performed using FD/MS “JMS-T100GC (manufactured by JEOL Ltd.)”. The analysis was performed in conditions of a sample amount of 1 mg (dissolved in 1 ml of chloroform), a cathode voltage of −10 kv, a spectrum recording interval of 0.4 s, and a measurement mass range of m/z 10 to m/z 2000. An intensity for the ester compound which was acquired for each number of carbon atoms (total of alcohol part and carboxylic acid part) in total was set to 100, and then a relative intensity (based on weight) for each number of carbon atoms was calculated to determine the maximum intensity.

### (4) Evaluation of Toner Performance

The toner obtained in Examples and Comparative Examples which will be described later was stirred by a Turbula mixer at a ratio of 6 pbw, with respect to 100 pbw of the ferrite carrier having an average particle size of 40 μm which was subjected to the surface coating of the silicone resin, to obtain a toner.

The obtained toner was charged to the developing device 5 of an image forming apparatus “e-STUDIO656” manufactured by TOSHIBA Corporation including the recycling device 29 of the waste toner of a structure shown in FIG. 1, separately toner was charged to the toner supply unit 21, and the following experiments were performed.

1. Fixing Offset Region

By improving a fixing system of the image forming apparatus, a fixing temperature was changed in a range of 120° C. to 160° C. to obtain 10 solid images. A case in which slight image peeling due to offset or non-fixing did not occur in 10 images thereof was evaluated as O, and a case in which the image peeling occurred was evaluated as X.

2. Photoreceptor Filming

A paper feeding test was performed by driving the recycling device 29 of the waste toner of the image forming apparatus. In a low-temperature low-humidity environment (10° C./20%), the paper feeding test of 100 k sheets was continuously performed with a printing rate 2% chart, and presence or absence of toner fixation (filming) on the photoreceptor was checked. A case in which the toner fixation did not occur on the photoreceptor was evaluated as O, and a case in which the toner fixation occurred was evaluated as X.

### <Preparation Example of Ester Wax>

### (Ester Wax A)

80 pbw of a long-chain alkyl carboxylic acid component selected from palmitic acid (C16H32O2), stearic acid (C18H36O2), arachidonic acid (C20H40O2), behenic acid (C22H44O2), and lignoceric acid (C24H48O2), and 20 pbw of a long-chain alkyl alcohol component selected from palmityl alcohol (C16H34O), stearyl alcohol (C18H38O), arachidyl alcohol (C20H42O), behenyl alcohol (C22H46O), and lignoceryl alcohol (C24H48O) were put into a four-necked flask to which a stirrer, a thermocouple, and a nitrogen introduction tube were attached, and an esterification reaction was performed at 220° C. under a nitrogen gas stream. After diluting the obtained reactant with a mixed solvent of toluene and ethanol, a sodium hydroxide aqueous solution was added thereto and the resultant material was stirred for 30 minutes at 70° C. After that, the resultant material was left for 30 minutes to remove a water layer portion. In addition, after adding ion-exchange water and stirring for 30 minutes at 70° C., an operation of leaving the resultant material for 30 minutes to remove the water layer portion was repeated 5 times, distilling away of the solvent from the obtained ester layer was performed under reduced pressure conditions, and ester wax A having an acid value of 0.1 mg KOH/g and a hydroxyl value of 0.5 mg KOH/g was obtained.

### (Ester Wax B and C)

In the preparation example of the ester wax A, ester wax B and C were prepared by changing the kinds and the amount of the long-chain alkyl carboxylic acid and the kinds and the amount of the long-chain alkyl alcohol. Particularly when spreading distribution, the adjustment thereof was performed by using the plurality of kinds for both of the long-chain alkyl carboxylic acid component and long-chain alkyl alcohol component.

### (Comparative Ester Wax D)

In the preparation example of the ester wax A, by increasing the combination amount of behenic acid and behenyl alcohol, comparative ester wax D in which ester compound of the number of carbon atoms (C44) with greatest frequency among the numbers of carbon atoms from C32 to C46 is 60% or more of the entire wax, was prepared. Data of the comparative ester wax (D) is shown in Table 1.

### (Comparative Ester Wax E)

Comparative ester wax (E) was prepared by only using palmitic acid as the acid component and palmityl alcohol as the alcohol component. Data of the comparative ester wax (E) is shown in Table 1.

The mass spectrometry (measurement of % by weight of the components of ester compound for each total number of carbon atoms), and measurement of melting point (DSC endothermic peak temperature), the acid value and the hydroxyl value of the ester waxes A to E were performed. The results are collectively shown in the following Table 1.

TABLE 1

| | | | | | | | | | | melting | | hydroxyl |
|---|---|---|---|---|---|---|---|---|---|---|---|---|
| | content (ratio) of ester compound (% by weight) | | | | | | | | | point | acid value | value |
| wax | C32 | C34 | C36 | C38 | C40 | C42 | C44 | C46 | C48 | [° C.] | [mgKOH/g] | [mgKOH/g] |
| A | 0 | 0 | 2.3 | 3.1 | 13.8 | 27 | 44.7 | 3.7 | 5.4 | 68 | 0.1 | 0.5 |
| B | 0 | 0 | 0 | 2.5 | 18.5 | 15.4 | 55 | 8.6 | 0 | 74 | 0.1 | 0.4 |
| C | 0 | 0 | 6 | 3.2 | 22.4 | 22.1 | 22 | 18.9 | 5.4 | 65 | 0.1 | 0.4 |
| D | 0 | 0 | 0 | 0.5 | 6.2 | 16.4 | 73 | 1 | 2.9 | 80 | 0.1 | 0.5 |
| E | 100 | 0 | 0 | 0 | 0 | 0 | 0 | 0 | 0 | 59 | 0.1 | 0.4 |

### <Preparation of Carnauba Wax>

For the carnauba wax, four types of carnauba wax with the endothermic peak temperatures of 80° C., 85° C., 90° C., and 95° C. were prepared by changing degrees of generation.

### Example 1

| | | |
|---|---|---|
| Polyester Resin (Binder) | 70 | pbw |
| Crystalline polyester resin | 15 | pbw |
| Wax | 8 | pbw |
| (the amounts of following components | | |
| were added to be 7:3) | | |
| Ester wax (B) | 5.6 | pbw |
| Carnauba wax (endothermic peak | 2.4 | pbw |
| temperature: 80° C.) | | |
| Magenta colorant (MA-100) | 6 | pbw |
| Charge control agent (Polysaccharide | 1 | pbw |
| compound containing Al + Mg) | | |

After mixing the materials described above by Henschel mixer, melting and kneading were performed by a twin screw extruder. The obtained molten and kneaded material was cooled, was coarse-crushed by a Hammer mill, and then fine-crushed by a jet mill for classification, to obtain powder toner particles having a volume average size of 7 μm.

The endothermic peak temperature of the obtained toner particles was measured with the DSC (DSC Q2000 (manufactured by TA Instruments. Japan)). The measurement thereof was performed in conditions of a sample amount of 5 mg, an cover and pan made of aluminum, a temperature rising rate of 10° C./min, and a measurement temperature of 20° C. to 200° C. The sample which was heated to 200° C. was cooled to 20° C. or lower, and was heated again, and the measured result was converted into data. The endothermic peak temperature occurring in the vicinity of 60° C. to 120° C. was set to a measurement value. A first peak (peak 1 derived from ester wax) was 75° C., a second peak (peak 2 derived from carnauba wax) was 80° C., and a temperature difference between the peaks was 5° C. In addition, a peak value derived from the crystalline polyester was 100° C.

The following additives were additionally combined with respect to 100 pbw of the powder toner particle by the Henschel mixer to prepare toner.

| | |
|---|---|
| Monodisperse hydrophobic silica having an average primary | 0.8 pbw |
| particle size of 82 nm | |
| hydrophobic silica having an average primary particle size of | 1 pbw |
| 30 nm | |
| hydrophobic titanium oxide having an average primary particle | 0.5 pbw |
| size of 20 nm | |

The evaluation of toner performance described above was performed for the obtained toner, and it was found that the offset was not generated in a range of 120° C. to 160° C. By further performing the paper feeding test, in the low-temperature and low-humidity environment (10° C./20%), it was found that there was no toner fixation on the photoreceptor after the test, although the paper feeding of 100 k sheets was continuously performed with a printing rate 2% chart.

The outlines and the evaluations are collectively shown in the following Table 2 with Examples and Comparative Examples which will be described later.

### Example 2

The toner was obtained and the evaluation of the performance thereof was performed in the same manner as Example 1, except for using the ester wax C instead of the ester wax B and the carnauba wax (endothermic peak temperature: 90° C.) instead of the carnauba wax (endothermic peak temperature: 80° C.)

### Example 3

The toner was obtained and the evaluation of the performance thereof was performed in the same manner as Example 1, except for using the ester wax C instead of the ester wax B.

### Example 4

The toner was obtained and the evaluation of the performance thereof was performed in the same manner as Example 1, except for using the carnauba wax (endothermic peak temperature: 90° C.) instead of the carnauba wax (endothermic peak temperature: 80° C.)

### Example 5

The toner was obtained and the evaluation of the performance thereof was performed in the same manner as Example 1, except for using the ester wax A instead of the ester wax B and the carnauba wax (endothermic peak temperature: 85° C.) instead of the carnauba wax (endothermic peak temperature: 80° C.), and changing the weight ratio between the two waxes to 40:60.

### Example 6

The toner was obtained and the evaluation of the performance thereof was performed in the same manner as Example 5, except for changing the weight ratio of the ester wax A and the carnauba wax (endothermic peak temperature: 85° C.) to 80:20.

### Example 7

The toner was obtained and the evaluation of the performance thereof was performed in the same manner as Example 5, except for changing the weight ratio of the ester wax A and the carnauba wax (endothermic peak temperature: 85° C.) to 70:30.

### Comparative Example 1

The toner was obtained and the evaluation of the performance thereof was performed in the same manner as Example 1, except for using 20.7 parts by weight of the ester wax (A) and the 2.3 parts by weight of the carnauba wax (90:10 as the weight ratio of ester wax:carnauba wax) as the wax, instead of using the crystalline polyester. When the fixing offset region was examined, it was found that the offset was generated at 120° C. to 140° C. since the crystalline polyester was not used.

### Comparative Example 2

The toner was obtained and the evaluation of the performance thereof was performed in the same manner as Example 1, except for using the carnauba wax (endothermic peak temperature: 95° C.) instead of the carnauba wax (endothermic peak temperature: 85° C.). When the fixing offset region was examined, it was found that the offset was generated at 120° C. to 130° C. since the endothermic peak temperature of the carnauba wax was high.

### Comparative Example 3

The toner was obtained and the evaluation of the performance thereof was performed in the same manner as Example 1, except for using the ester wax E (endothermic peak temperature: 60° C.) instead of the ester wax B. When the fixing offset region was examined, the high temperature offset was generated at 160° C. In addition, in the low-temperature and low-humidity environment (10° C./20%), in the continuous paper feeding test with a printing rate 2% chart, since the endothermic peak temperature of the ester wax was low, contamination was found on the paper from the vicinity of the 70 k-th sheet, and when the test was stopped and the device was taken apart, the toner fixation was found on the photoreceptor.

### Comparative Example 4

The toner was obtained and the evaluation of the performance thereof was performed in the same manner as Example 3, except for changing the weight ratio of the ester wax C and the carnauba wax (endothermic peak temperature: 80° C.) to 90:10. When the fixing offset region was examined, the low temperature offset was generated in a range of 120° C. to 130° C. In addition, in the low-temperature and low-humidity environment (10° C./20%), in the continuous paper feeding test with printing rate 2% chart, since the endothermic peak temperature of the ester wax was low, contamination was found on the paper from the vicinity of the 70 k-th sheet, and when the test was stopped and the device was taken apart, the toner fixation was found on the photoreceptor.

### Comparative Example 5

The toner was obtained and the evaluation of the performance thereof was performed in the same manner as Comparative Example 2, except for using the ester wax D instead of the ester wax A. When the fixing offset region was examined, it was found that the offset was generated in a range of 120° C. to 140° C. since a ratio of the ester wax was small.

### Comparative Example 6

The toner was obtained and the evaluation of the performance thereof was performed in the same manner as Example 3, except for changing the weight ratio of the ester wax C and the carnauba wax (endothermic peak temperature: 80° C.) to 30:70. When the fixing offset region was examined, it was found that the offset was generated in a range of 120° C. to 130° C., due to the high endothermic peak temperature of the ester wax in addition to the high endothermic peak temperature of the carnauba wax.

The outlines and a summary of the evaluation results of the Examples and Comparative Examples are shown in the following Table 2.

TABLE 2

| | | | DSC peak temperature in toner wax | | | | | |
|---|---|---|---|---|---|---|---|---|
| | | | (° C.) | | | | | |
| | | | | | peak | | | |
| | crystal | used | ester | carnauba | temperature | weight ratio of | fixing | photo- |
| | line | ester | wax | wax | difference | ester wax:car- | offset | receptor |
| | polyester | wax | peak 1 | peak2 | P2 − P1 | nauba wax | region | filming |
| Example1 | used | B | 75 | 80 | 5 | 70:30 | ◯ | ◯ |
| Example2 | used | C | 65 | 90 | 25 | 70:30 | ◯ | ◯ |
| Example3 | used | C | 65 | 80 | 15 | 70:30 | ◯ | ◯ |
| Example4 | used | B | 74 | 90 | 16 | 70:30 | ◯ | ◯ |
| Example5 | used | A | 68 | 85 | 17 | 40:60 | ◯ | ◯ |
| Example6 | used | A | 68 | 85 | 17 | 80:20 | ◯ | ◯ |
| Example7 | used | A | 68 | 85 | 17 | 70:30 | ◯ | ◯ |
| Comparative | not | A | 68 | 80 | 12 | 90:10 | X | ◯ |
| Example1 | used | | | | | | | |
| Comparative | used | A | 68 | 95 | 27 | 70:30 | X | ◯ |
| Example2 | | | | | | | | |
| Comparative | used | E | 60 | 80 | 20 | 70:30 | X | X |
| Example3 | | | | | | | | |
| Comparative | used | C | 65 | 80 | 15 | 90:10 | X | X |
| Example4 | | | | | | | | |
| Comparative | used | C | 65 | 80 | 15 | 30:70 | X | ◯ |
| Example5 | | | | | | | | |
| Comparative | used | D | 80 | 95 | 15 | 70:30 | X | ◯ |
| Example6 | | | | | | | | |

While certain embodiments have been described, these embodiments have been presented by way of example only, and are not intended to limit the scope of the inventions. Indeed the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A toner comprising:
a binder resin;
a colorant;
a wax including 40 to 80 weight percent of an ester wax having an endothermic peak temperature of 65 to 75° C. in a differential scanning calorimetry curve and 60 to 20 weight percent of a carnauba wax having an endothermic peak temperature of 80 to 90° C. in the differential scanning calorimetry curve; and
a crystalline polyester material,
wherein, with respect to the total weight of the binder resin, the wax, and the crystalline polyester material, the wax comprises to 10 weight percent and the crystalline polyester material comprises 3 to 20 weight percent.

2. The toner according to claim 1, wherein the binder resin comprises a polyester resin.

3. The toner according to claim 2, wherein a softening temperature of the crystalline polyester material is 95 to 110° C., a ratio of the softening temperature to a maximum endothermic peak temperature is 0.6 to 1.3, and an acid value is 5 to 15 mg-KOH/g.

4. The toner according to claim 3, wherein the ester wax comprises a mixture of ester compounds, each having 36 to 48 carbon atoms.

5. The toner according to claim 4, wherein one or more of the ester compounds that have a same number of carbon atoms comprises in total less than 60 weight percent with respect to each of the ester compounds.

6. The toner according to claim 2, wherein the ester wax comprises a mixture of ester compounds, each having 36 to 48 carbon atoms.

7. The toner according to claim 6, wherein one or more of the ester compounds that have a same number of carbon atoms comprises in total less than 60 weight percent with respect to each of the ester compounds.

8. The toner according to claim 1, wherein the binder resin comprises amorphous polyester having a softening temperature of 100 to 115° C., a ratio of the softening temperature to a maximum endothermic peak temperature of greater than 1.3, a glass transition temperature of 55 to 65° C., and an acid value of 5 to 20 mg-KOH/g.

9. The toner according to claim 8, wherein the ester wax comprises a mixture of ester compounds, each having 36 to 48 carbon atoms.

10. The toner according to claim 9, wherein one or more of the ester compounds that have a same number of carbon atoms comprises in total less than 60 weight percent with respect to each of the ester compounds.

11. The toner according to claim 10, wherein a softening temperature of the crystalline polyester material is 95 to 110° C., a ratio of the softening temperature to a maximum endothermic peak temperature is 0.6 to 1.3, and an acid value is 5 to 15 mg-KOH/g.

12. The toner according to claim 9, wherein a softening temperature of the crystalline polyester material is 95 to 110° C., a ratio of the softening temperature to a maximum endothermic peak temperature is 0.6 to 1.3, and an acid value is 5 to 15 mg-KOH/g.

13. The toner according to claim 8, wherein a softening temperature of the crystalline polyester material is 95 to 110° C., a ratio of the softening temperature to a maximum endothermic peak temperature is 0.6 to 1.3, and an acid value is 5 to 15 mg-KOH/g.

14. The toner according to claim 1, wherein a softening temperature of the crystalline polyester material is 95 to 110° C., a ratio of the softening temperature to a maximum endothermic peak temperature is 0.6 to 1.3, and an acid value is 5 to 15 mg-KOH/g.

15. The toner according to claim 14, wherein the ester wax comprises a mixture of ester compounds, each having 36 to 48 carbon atoms.

16. The toner according to claim 15, wherein one or more of the ester compounds that have a same number of carbon atoms comprises in total less than 60 weight percent with respect to each of the ester compounds.

17. The toner according to claim 1, wherein the ester wax comprises a mixture of ester compounds, each having 36 to 48 carbon atoms.

18. The toner according to claim 17, wherein one or more of the ester compounds that have a same number of carbon atoms comprises in total less than 60 weight percent with respect to each of the ester compounds.

19. An image forming apparatus, comprising:
a photoreceptor;
an exposing unit configured to form an electrostatic latent image on the photoreceptor;
a developing unit configured to develop a toner image with toner based on the electrostatic latent image on the photoreceptor; and
a transfer unit configured to transfer the toner image onto a medium,
wherein the toner comprising:
a binder resin;
a colorant;
a wax including 40 to 80 weight percent of an ester wax having an endothermic peak temperature of 65 to 75° C. in a differential scanning calorimetry curve and 60 to 20 weight percent of a carnauba wax having an endothermic peak temperature of 80 to 90° C. in the differential scanning calorimetry curve; and
a crystalline polyester material, and
wherein, with respect to the total weight of the binder resin, the wax, and the crystalline polyester material, the wax comprises 4 to 10 weight percent and the crystalline polyester material comprises 3 to 20 weight percent.

20. The image forming apparatus according to claim 19, further comprising:
a cleaning unit configured to recover residual toner remaining on the photoreceptor; and
a recycling unit configured to supply the recovered residual toner to the developing unit,
wherein the developing unit is configured to develop the toner image with the recovered residual toner.
